(19) United States
(12) Patent Application Publication
(10) Pub. No.: US 2013/0204093 A1
(43) Pub. Date: Aug. 8, 2013

(54) LARGE CETACEAN MOUTH SPECULUM

(71) Applicant: OCEANEERING INTERNATIONAL, INC., Orlando, FL (US)

(72) Inventors: David C. Mauck, Orlando, FL (US); John Linn, Orlando, FL (US); Allen L. Williams, Seabrook, TX (US)

(73) Assignee: OCEANEERING INTERNATIONAL, INC., Orlando, FL (US)

(21) Appl. No.: 13/751,472

(22) Filed: Jan. 28, 2013

Related U.S. Application Data
(60) Provisional application No. 61/596,006, filed on Feb. 7, 2012.

(51) Int. Cl. A61D 15/00

(52) U.S. Cl. CPC A61D 15/00
USPC 600/243

(57) ABSTRACT

A speculum useable for large mammals, such as cetaceans, has (a) a handle with a proximate end and a distal end; (b) a pair of expandable jaws attached to the distal end of the handle, the pair of jaws being adapted to effectively and humanly opening the mouth of a large cetacean; and (c) a jaw actuator for expanding the jaws.

### RELATED APPLICATION

This application claims priority from U.S. Provisional Application Ser. No. 61/596,006, filed on Feb. 7, 2012, entitled SPREADER TOOL, the entirety of which is incorporated herein by reference.

### FIELD OF THE INVENTION

This invention is directed to animal husbandry, and, more specifically, to animal husbandry of large mammals, especially large aquatic animals such as cetaceans.

### BACKGROUND OF THE INVENTION

Specula for opening the jaws of large animals are frequently desired for veterinary examinations and other veterinary procedures. Prior art specula for such applications, however, are typically very large, cumbersome, expensive and/or awkward to operate. Moreover, many prior art specula require that the animal be sedated.

Accordingly, there is a need for a speculum which is portable, easy to operate and relatively inexpensive.

### SUMMARY OF THE INVENTION

The invention satisfies this need. The invention is a speculum comprising (a) a handle having a proximate end and a distal end; (b) a pair of expandable jaws attached to the distal end of the handle, the pair of jaws being adapted to effectively and humanly opening the mouth of a large animal; and (c) a spreader jaw actuator for expanding the jaws.

### DRAWINGS

These and other features, aspects and advantages of the present invention will become better understood with reference to the following description, appended claims and accompanying drawings where:

FIG. 1 is a perspective view of a speculum having features of the invention, showing the jaws in a closed position;

FIG. 2 is a second perspective view of the invention illustrated in FIG. 1, showing the jaws in an open position;

FIG. 3 is a detail top view of the jaws of the invention illustrated in FIG. 1;

FIG. 4 is a side view of a single jaw useable in the invention of FIG. 1; and

FIG. 5 is a top view of the jaw illustrated in FIG. 4.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a mouth speculum 10 for use with large animals, including large aquatic mammals, such as cetaceans. The speculum 10 comprises a handle 12, a pair of expandable jaws 14 at one end of the handle 12 and a jaw actuator 16 for expanding the jaws 14.

The handle 12 has a proximal end 18 and a distal end 20. The handle 12 is typically about 4-5 feet in length to allow the user to position himself or herself away from the animal. The handle 12 is made from a strong, lightweight material, such as machined aluminum. To lighten the weight of the handle 12, the handle 12 can define a hollow shaft running axially from near the proximal end 18 to the distal end 20, and can define grooves cut into the sides of the handle 12.

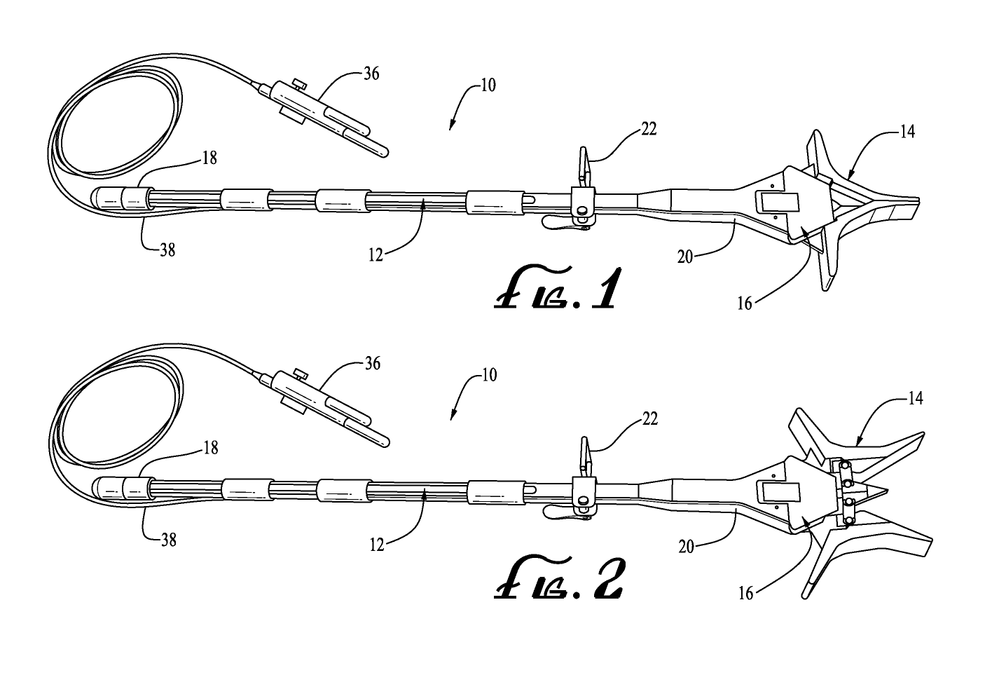

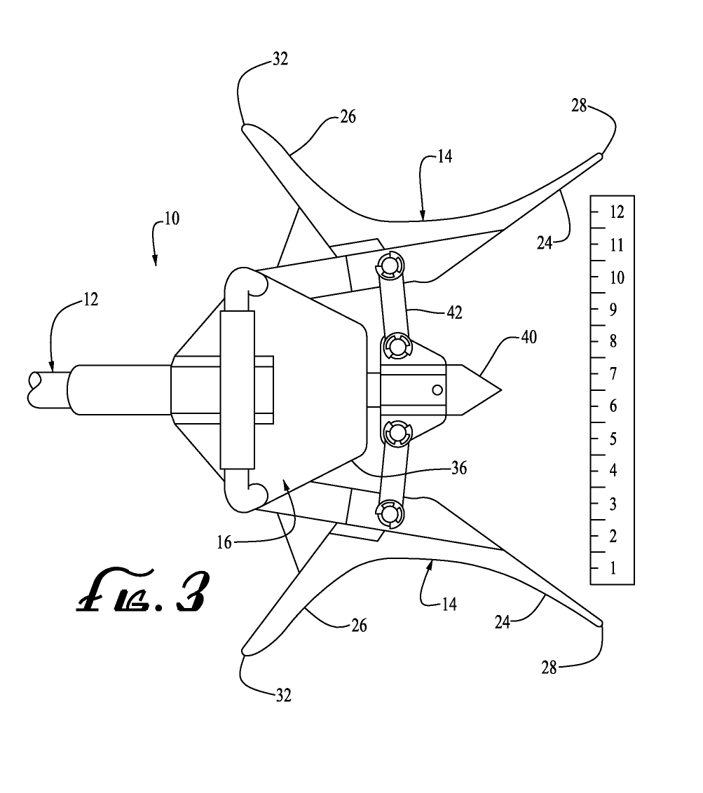

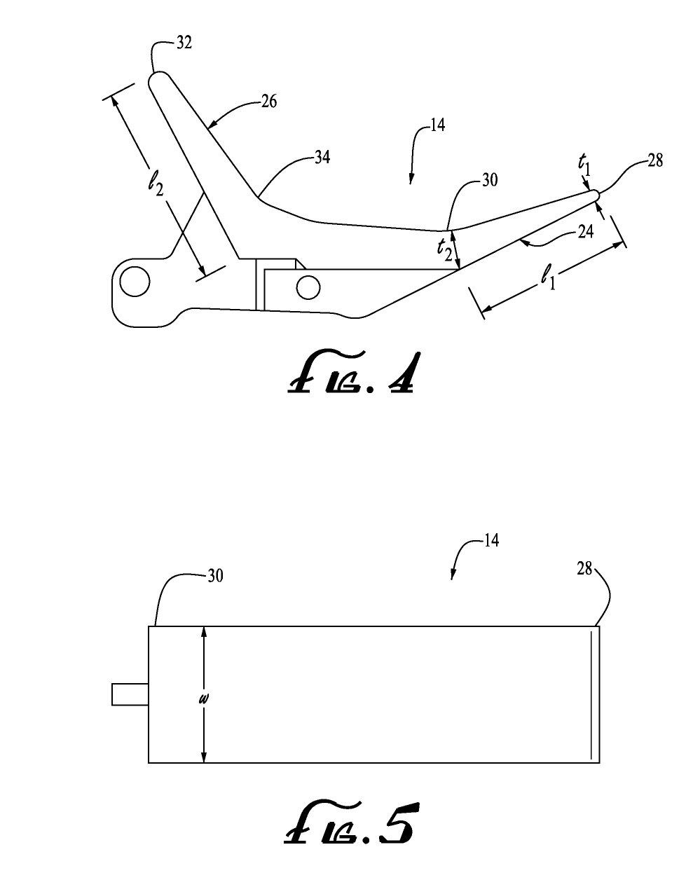

Preferably, much of the handle 12 is covered with a rubber or other similar material for ease of handling. The handle 12 can have a variety of cross-sectional shapes. In the embodiment illustrated in the drawings, the cross-sectional shape of the handle 12 is a square. As illustrated in FIGS. 1 and 2, the handle 12 can further comprise a moveable D handle 22 for convenient retention of the handle 12 by one hand of a user.

For ease in handling, the handle 12 is preferably balanced with a counterweight near the distal end 20 of the handle 12.

The pair of expandable jaws 14 are disposed at the distal end 20 of the handle 12. The expandable jaws 14 are adapted to effectively and humanely open the mouth of a large animal. Each of the jaws 14 comprises a tip portion 24 and a wing portion 26. The tip portions 24 of the jaws 14 are designed to slip into a small area of the animal's mouth, and expand the opening of the mouth—with force if necessary. The wing portions 26 of the jaws 14 provide a stop mechanism to prevent the user from inserting the speculum 10 too far into the mouth of the animal and to provide a seat for retaining the animal's jaws.

The pair of jaws 14 are adapted to interact with one another between (i) a closed jaw position wherein the tip portions 24 of the pair of expandable jaws 14 are in contact with one another, and (ii) an open position wherein the tip portions 24 of the pair of expandable jaws 14 are spaced apart from one another. As illustrated in FIG. 3, the tip portions 24 of the jaws 14, when in the open position, can be spaced apart from one another by 12 inches-15 inches.

Each tip portion 24 has a distal end 28 and a proximal end 30, and each wing portion 26 has a distal end 32 and a proximal end 34. The proximal end 34 of each wing portion 26 is attached to the proximal end 30 of a tip portion 24.

Each of the wing portions 26 extends away from the tip portion 24 at an angle between about 75° and about 105°, preferably between about 85° and about 100°. Larger angles may allow the tip portion 24 to slip too far into the animal's mouth and may not properly center the tip portion 24 into the animal's mouth. Smaller angles may allow the tip portion 24 to enter the animal's mouth with undue force. In the embodiment illustrated in the drawings, the wing portion 26 extends away from the tip portion 24 at an angle of about 90°.

In the most usual application, the speculum 10 is inserted at the gum line, aft of the animal's teeth. If something is in the animal's mouth, however, the speculum 10 may need to be moved forward. Also for clinical use, the speculum 10 can be positioned at the front of the mouth of a sedated animal.

The width w of the tip portion 24 may vary with the animals for which the speculum 10 is used. Where the speculum 10 is used for a killer whale, the width w of the tip portion 24 is preferably between about 2.5 inches and about 4 inches. The width w of the tip portion 24 is based on the average gap at the killer whale's jaw/gum line just aft of where the teeth start.

The thicknesses t₁ of the distal end 28 of the tip 24 of each jaw may also depend on the animals for which the speculum 10 is used. Where the speculum 10 is used for a killer whale, the thickness t₁ of the distal end 28 of the tip 24 is between about ⅛ inch and about ½ inch. Less than a ⅛ inch thickness provides insufficient strength against yielding. Larger than a ½ inch thickness could be cumbersome.

For a killer whale, the thickness t₂of the proximal end 30 of the tip portion 24 of each jaw 14 is between about ¾ inch and about 1 inch. The increased thickness t₂ at the proximal end 30 of the tip portion 24 is preferred to allow insertion until contact with teeth/gum if an object is wedged in the killer whale's mouth. Any thickness t₂ of the proximal end 30 of the tip portion 24 less than ½ inch would place the tip portion 24 in danger of failure. Any thickness greater than one inch would cause undue weight addition.

For killer whales, the length l₁ of the tip portion 24 is preferably between about 6 inches and about 9 inches. Lengths less than 6 inches fail to provide a means for wedging the tip portion 24 in and still providing a solid seating area. Lengths greater than 9″ are unnecessary.

For killer whales, the length l₂ of the wing portion 26 is preferably between about 2.5 inches and about 4 inches. Lesser lengths may not provide a proper stop, and greater lengths are unnecessary.

Typically, the jaws 14 are made from machined aluminum.

The jaw actuator 16 is adapted to move the pair of jaws 14 from the closed position to the open position. The actuator 16 is powered by any of a variety of suitable power sources, including hydraulic and electrical power sources. In the embodiment illustrated in the drawings, the actuator 16 comprises a hydraulic cylinder and the actuator 16 is powered by hydraulic fluid. Such an actuator 16 can be purchased from Hurst Jaws of Life of Shelby, N.C. as the Hurst Mini-Lite Spreader.

The source of hydraulic fluid for the actuator 16 is typically a hydraulic pump disposed near the proximal end of the handle 18. Electrical or battery-operated pumps can also be used, but they typically entail increased weight, expense and limitation of handling.

In the embodiment illustrated in the drawings, the hydraulic pump is an air pump 36. The air pump 36 is connected to the actuator 16 by a tube 38 extending the length of the handle 12. In the embodiment illustrated in the drawings, the tube 38 is affixed to the exterior of the handle 12. In an alternative embodiment, the tube 38 can be disposed within a hollow central channel defined axially within the handle 12.

In the embodiment illustrated in the drawings, the actuator 16 comprises a hydraulically driven ram 40 which can be axially driven away from the distal end of the handle 12. The hydraulically driven ram 40 operates linkages 42 which are operatively connected to each of the expandable jaws 14 to move the jaws 14 from the closed position to the open position.

Preferably, the actuator 16 is easily detached from and reattached to the handle 12 for required maintenance or replacement.

The speculum 10 can be conveniently employed in non-emergency applications, such as in clinical support and animal husbandry. The speculum 10 can also be used in emergency situations. The speculum 10 provides an irritation of light pressure to the gum line of the animal to cause the animal to open its mouth. If such irritation is insufficient to cause the animal to open its mouth, the speculum 10 can provide sufficient pressure to force the animal to open its mouth.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A mouth speculum suitable for use with a large animal, the speculum comprising:
(a) a handle having a proximate end and a distal end;
(b) a pair of expandable jaws attached to the distal end of the handle, the pair of jaws being adapted to effectively and humanly opening the mouth of a large animal; and
(c) a spreader jaw actuator for expanding the jaws.

2. The speculum of claim 1 wherein each of the pair of expandable jaws comprises (i) a tip portion having a distal end and a proximal end, and (ii) a wing portion having a distal end and a proximal end, the proximal end of each wing portion being attached to the proximal end of a tip portion and extending away from the tip portion at an angle between about 75° and about 105°.

3. The speculum of claim 2 wherein each wing portion extends away from the tip portion at an angle between about 85° and about 100°.

4. A mouth speculum suitable for use with a killer whale, the speculum comprising:
(a) a handle having a proximate end and a distal end;
(b) a pair of expandable jaws attached to the distal end of the handle, the pair of expandable jaws comprising (i) a tip portion having a distal end and a proximal end, and (ii) a wing portion having a distal end and a proximal end, each proximal end of the wing portion being attached to the proximal end of a tip portion and extending away from the tip portion at an angle between about 75° and about 105°; and
(c) a spreader jaw actuator for expanding the jaws.

5. The speculum of claim 4 wherein each wing portion extends away from the tip portion at an angle between about 85° and about 100°.

6. The speculum of claim 4 wherein the width of the tip portion is between about 2.5 inches and about 4 inches.

7. The speculum of claim 4 wherein the thickness of the distal end of the tip portion is between about ⅛ inch and about ½ inch.

8. The speculum of claim 4 wherein the thickness of the proximal end of the tip portion is between about ¾ inch and about 1 inch.

9. The speculum of claim 4 wherein the length of the tip portion is between about 6 inches and about 9 inches.

10. The speculum of claim 4 wherein the length of the wing portion is between about 2.5 inches and about 4 inches.

11. A speculum suitable for use with a killer whale, the speculum comprising:
(a) a handle having a proximate end and a distal end;
(b) a pair of expandable jaws attached to the distal end of the handle; and
(c) a spreader jaw actuator for expanding the jaws; wherein:
(d) each of the pair of expandable jaws comprises (i) a tip portion having a distal end and a proximal end, and (ii) a wing portion having a distal end and a proximal end, the proximal end of each wing portion being attached to the proximal end of a tip portion and extending away from the tip portion at an angle between about 75° and about 105°;
(e) the width of the tip portion is between about 2.5 inches and about 4 inches;
(f) the thickness of the distal end of the tip portion is between about ⅛ inch and about ½ inch;
(g) the thickness of the proximal end of the tip portion is between about ¾ inch and about 1 inch;
(h) the length of the tip portion is between about 6 inches and about 9 inches; and
(i) the length of the wing portion is between about 2.5 inches and about 4 inches.

12. The speculum of claim 11 wherein each wing portion extends away from the tip portion at an angle between about 85° and about 100°.
